(19) United States
(12) Patent Application Publication
(10) Pub. No.: US 2014/0131542 A1
(43) Pub. Date: May 15, 2014

(54) Vehicle Seat Suspension With Conical Roller Stabilized Isolator

(71) Applicants: Nic Hodnefield, Taylor Ridge, IL (US); Wayne Ward, Bettendorf, IA (US)

(72) Inventors: Nic Hodnefield, Taylor Ridge, IL (US); Wayne Ward, Bettendorf, IA (US)

(21) Appl. No.: 13/675,558

(22) Filed: Nov. 13, 2012

(51) Int. Cl. B60N 2/04

(52) U.S. Cl. CPC B60N 2/04
USPC 248/419

(57) ABSTRACT

A vehicle seat suspension has lower and upper housings with the upper housing adapted to support the seat and having longitudinally extending side tracks. A linkage assembly having a plurality of links connects the lower and upper housing. A plurality of side rollers are mounted to the links and ride in the side tracks, each rotating on a horizontally extending axis. Each of the side rollers has an outer conical bearing surface and each of the side tracks has an angled outside wall. The outer conical bearing surface of each side roller and the angled outside wall of each side track have an angle relative to vertical to facilitate their rolling engagement. The side rollers engage the longitudinal tracks at spaced locations to stabilize the upper housing in a direction generally perpendicular to its fore and aft travel path.

### BACKGROUND

The present invention is directed generally to vehicle seating. More particularly, the invention is directed to a vehicle seat suspension employing an integrated isolator system that is stabilized to enhance seat suspension performance.

It is now common in vehicle seat technology to provide mechanisms or systems that reduce the undesirable effects of forces inputted to the seat from the front, back or sides. These so called “isolators,” both “fore and aft” and “lateral” varieties, commonly have an isolator plate with side tracks that travels in a reciprocal manner on a set of rollers. These conventional isolators, however, suffer from certain disadvantages. Because of dimensional and tolerance constraints, these prior art isolator systems have a tendency to cant or “rack,” increasing the interference and friction between the tracks and rollers. In addition, when the vehicle is on uneven terrain, which is often the case with off-the-road vehicles, the isolator tracks may bear against the sides of rollers, again generating undesirable interference and friction. Either or both of these problems can reduce the useful life of the suspension or require repair. Finally, the prior art isolators may cause a perceived “looseness” in the seat ride which is undesirable to the occupant.

Recently, an improved vehicle seat isolator with lateral stabilization has been introduced to the market and is disclosed in U.S. Pat. No. 7,922,142. While the disclosed apparatus is functionally satisfactory and represents a significant improvement over the prior art, the disclosed scissors suspension assembly and isolator are separate components thereby adding to U.S. patent application Ser. No. 13/476,250 and owned by the assignee of this application, employs vertical rollers mounted to the top of a scissors suspension in order to stabilize the isolator from laterally inputted forces.

### SUMMARY OF THE INVENTION

The present invention is directed to a vehicle seat suspension having a stabilized or guided isolator system that overcomes the disadvantages of the prior art. Moreover, the present invention provides enhanced isolator performance in a mechanically simple, reliable and inexpensive design. Importantly, the present invention integrates the isolator function in a scissors suspension assembly so that the overall apparatus is more compact and requires a smaller operational envelope. To that end, certain of the conventional scissors suspension components serve functions both with respect to vertical suspension and horizontal isolation.

In accordance with the present invention a vehicle seat suspension apparatus is provided having lower and upper housings with the upper housing adapted to support a vehicle seat and having longitudinally extending side tracks. A linkage assembly having a plurality of links connects the lower and upper housing, thus permitting vertical movement of the upper housing relative to the lower housing. A plurality of side rollers, each rotating on a horizontally extending axis, are connected to the upper ends of the linkage assembly links, the side rollers being positioned within and moveable along a portion of the upper housing side tracks thereby permitting the upper housing to move horizontally along a fore and aft travel path relative to the lower housing. Each of the side rollers has a cylindrical bearing surface and an outer conical bearing surface and each of the side tracks has bottom and top walls and an angled outside wall. The outer conical bearing surface of each side roller and the angled outside wall of each side track have an angle relative to vertical to facilitate rolling engagement between the side rollers and the outside wall of the side track. The side rollers engage the longitudinal tracks at spaced locations to thereby stabilize the upper housing in a direction generally perpendicular to its fore and aft travel path.

### BRIEF DESCRIPTION OF THE DRAWINGS

The novel features of the present invention are set forth in the appended claims. However, the invention's preferred embodiments, together with further objects and attendant advantages, will be best understood by reference to the following detailed description taken in connection with the accompanying drawings in which:

FIG. 1 is a perspective view one preferred embodiment of the present invention with certain parts partially broken away to more clearly illustrate internal components;

FIG. 2 is a front elevation view of the embodiment of the invention shown in FIG. 1, with parts of the apparatus shown in cross section taken along line 2-2 of FIG. 1;

FIG. 3 is a cross section view taken along line 3-3 of FIG. 1 and illustrating further construction details of the embodiment illustrated in FIG. 1; and

FIG. 4 is a partial cross section taken along line 4-4 of FIG. 3.

### DETAILED DESCRIPTION OF THE PREFERRED EMBODIMENTS

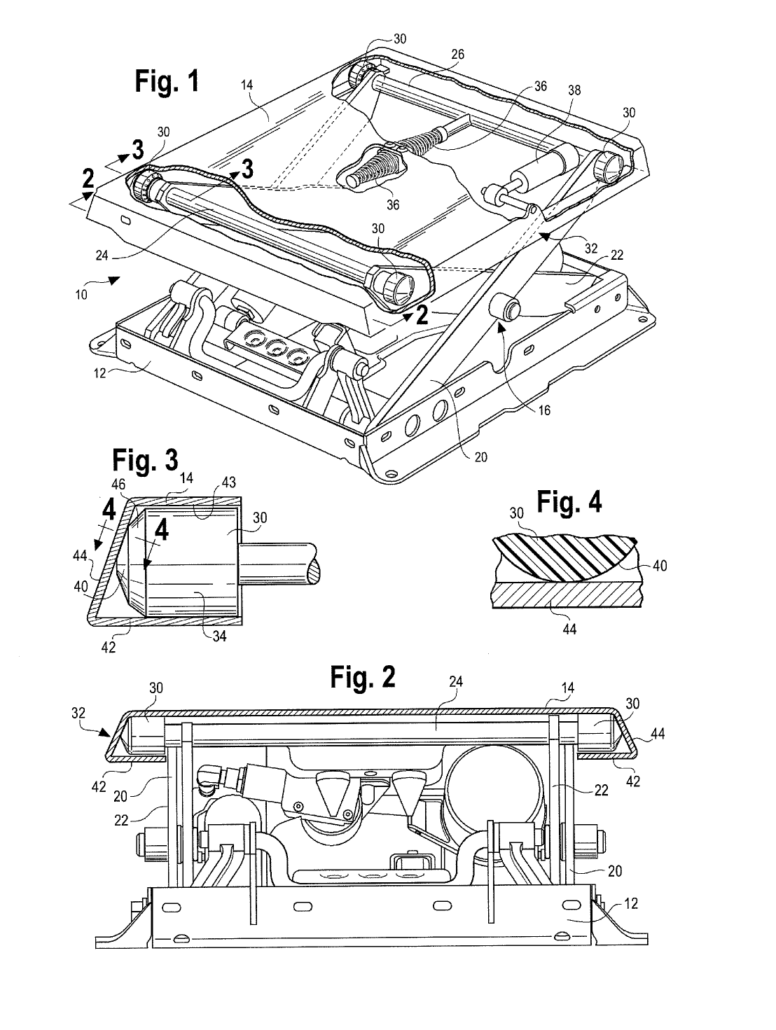

With reference to FIGS. 1 and 2, the improved seat suspension of the present invention is designated generally as 10, and includes a lower housing or base 12, an upper housing or platform 14 and a scissors linkage assembly 16. The scissors linkage assembly is well known to those of skill in the art and will not be disclosed here in any detail. However, it is generally comprised of two pair of scissors links, each link of the outer pair designated as 20 and each link of the inside pair being designated as 22. In addition, a front cross member or shaft 24 connects the upper ends of the inside links 22, while a rear cross member or shaft 26 connects the upper ends of the outside links 20. Side rollers 30 are positioned adjacent to the upper ends of links 20 and 22 and extend laterally outward from those links along generally horizontal axes of rotation. The upper housing 14 includes longitudinally extending side tracks 32 which house side rollers 30, thereby permitting the upper housing to reciprocate or move back and forth along a fore aft path of travel relative to the lower housing 12. The upper housing 14 is also mechanically connected to the scissors linkage assembly via a pair of springs 36 and a shock absorber 38 in order to provide dampened isolation of the upper housing, and the seat and vehicle operator supported by this housing, from undesirable forces inputted to the seat suspension as the vehicle passes over uneven surfaces. In this manner, in accordance with the preferred embodiment of the invention, the isolator and scissors suspension structures are integrated, providing a more compact and efficient seat suspension assembly.

The aforementioned U.S. Pat. No. 7,922,142 and U.S. patent application Ser. No. 13/476,250 address the side load problem which exists with seat isolation devices when the vehicle is subjected to uneven riding conditions. The side loads input to the isolation device may cause premature failure of the rollers employed in the structure or canting of the isolator. The problem may be ameliorated by precise dimensioning of the device and careful fabrication techniques, but these approaches are difficult and costly. The inventions described in the above noted patent and application offer solutions to the problem. The present invention solves the same problem in a different, novel and non obvious manner as compared to the prior art.

In accordance with the present invention and as shown in the preferred embodiments, the side load problem may be minimized, if not entirely eliminated, by use of side rollers 30 and side tracks 32 configured to permit rolling engagement between these components when undesirable side loads are input to the system, as typically occurs when the vehicle operates over uneven terrain.

More particularly, in accordance with the disclosed preferred embodiment of the invention, the side rollers 30 have both a conventional cylindrical bearing surface 34 and a conical outer bearing surface 40. Also, the side tracks 32 include conventional bottom and top walls, 42 and 43 respectively, and an angled outside wall 44. As illustrated in FIGS. 3 and 4, the angle formed by the conical bearing surface 40 relative to vertical generally matches the angle also formed by the angled outside wall 44 relative to vertical. When the vehicle is operated on flat terrain, the cylindrical bearing surfaces 34 engage the top walls 43 and carry substantially all of the load input from the seat an operator. However, when the vehicle is operated on uneven terrain, the conical bearing surfaces 40 will engage and roll smoothly against the inside surfaces of outside walls 44 carry the lateral load input from the seat and operator, thereby substantially reducing friction and wear of these components. In addition, because the side rollers 30 are positioned separately from one another a substantial distance along the length of each side track 32, the potential for canting or racking of the isolator is substantially reduced.

As illustrated, the side rollers 30 may also include a chamfer 46 disposed between the cylindrical and conical bearing surfaces. In addition, the precise angle formed by each of the conical bearing surface and angled outside wall may vary depending upon the particular needs of the suspension system; however, an angle of between about 5 and 20 degrees has been found particularly suitable.

It will be appreciated by those skilled in the art that various changes and modifications can be made to the illustrated embodiments without departing from the spirit of the present invention. All such modifications and changes are intended to be covered by the appended claims.

1. A vehicle seat suspension apparatus comprising:
a lower housing;
an upper housing adapted to support a vehicle seat and having longitudinally extending side tracks;
a linkage assembly including a plurality of links connecting the lower and upper housings and permitting vertical movement of the upper housing relative to the lower housing;
a plurality of side rollers each rotating on a horizontally extending axis and connected to an upper end of one of the links of said linkage assembly, said side rollers positioned within and movable along a portion of the upper housing side tracks thereby permitting the upper housing to move horizontally relative to the lower housing;
each of said side rollers having a cylindrical bearing surface and an outer conical bearing surface;
each of said side tracks having a bottom wall and an angled outside bearing surface wall; and
the outer conical bearing surface of each side roller and the angled outside bearing surface wall of each side track having an angle relative to a vertical axis to facilitate rolling engagement between the side rollers and the outside wall of the side track, wherein said vertical axis is perpendicular to said horizontally extending axis.

2. The vehicle seat suspension apparatus of claim 1 wherein said angle is between 5 and 20 degrees.
